(19) United States
(12) Patent Application Publication
(10) Pub. No.: US 2024/0359557 A1
(43) Pub. Date: Oct. 31, 2024

(54) DISPLAY SYSTEM AND MOTOR VEHICLE HAVING A DISPLAY SYSTEM

(71) Applicant: AUDI AG, Ingolstadt (DE)

(72) Inventors: Christian WALL, Hitzhofen (DE); Johannes HEROLD, Dresden (DE); Jens SCHIRMER, Dresden (DE)

(73) Assignee: AUDI AG, Ingolstadt (DE)

(21) Appl. No.: 18/579,757

(22) PCT Filed: Jul. 8, 2022
(86) PCT No.: PCT/EP2022/069120

§ 371 Date: Jan. 16, 2024

(30) Foreign Application Priority Data
Jul. 19, 2021 (DE) 10 2021 118 524.6

(51) Int. Cl. B60K 35/22; B60K 35/53; B60R 11/00; B60R 11/02

(52) U.S. Cl. CPC B60K 35/223; B60K 35/53; B60R 11/0235; B60K 2360/682; B60R 2011/0084; B60R 2011/0092

(57) ABSTRACT

A display system includes a display apparatus with a screen carrier to which a flexible screen film is fastened, and a housing with a housing interior space for at least partially receiving the display apparatus. The display apparatus can be moved through a housing opening between use positions. The screen carrier includes, in a first carrier portion, a first inherent rigidity so that the first carrier portion is bendable and/or foldable. Guide rails fixed with respect to the housing and of curved shape in the housing interior space define a curved movement path for the screen carrier. The carrier portion has guide elements mounted to be movable along the guide rails. A respective guide element is in form-fitting engagement with its respective guide rail transversely with respect to the movement path, such that, during a movement along the movement path, the display apparatus is retained on the guide rails.

### CROSS REFERENCE TO RELATED APPLICATIONS

This application is a U.S. national stage of International Application No. PCT/EP2022/069120 filed on Jul. 8, 2022. The International Application claims the priority benefit of German Application No. 10 2021 118 524.6 filed on Jul. 19, 2021. Both the International Application No. PCT/EP2022/069120 and the German Application No. 10 2021 118 524.6 are incorporated by reference herein in their entirety.

### BACKGROUND

Disclosed herein is a display system with a display apparatus and a housing, wherein the display apparatus can be at least partially received or retracted in the housing. The display apparatus comprises a screen for displaying display content for an observer, wherein the fact that the display apparatus can be at least partially received in the housing makes it possible to adjust a visible size of the screen for the observer as required. Also disclosed herein is a motor vehicle having such a display system.

In the course of technical development and in particular in connection with the development of partially autonomous or fully autonomous motor vehicles, the trend is toward ever larger screens or display apparatuses in the passenger interior space, which are designed to provide an observer with diverse display content or information. This includes not only travel-related and/or vehicle-related information, such as a current traveling speed and/or route data (navigation data), but also entertainment options, such as games and/or films. This has the result that a respective size of a screen or of a display is not always optimally suited to the respective display content. There is thus the possibility of information which could be displayed on a relatively small surface being displayed on an unnecessarily large display or screen, which can otherwise unfavorably influence the observer's view of the traffic scene. If a screen is selected to be smaller to avoid this effect, there is the possibility of for example films not being able to be displayed in a desired image size. There is thus a need for display apparatuses with variable-size screens.

This need exists not only in motor vehicles but also in other sectors, for example in an office environment. Here, it may be necessary to be able to optimally utilize the spatial conditions in a workplace by way of size-adjustable screens. A screen which is able to be stowed in a housing also makes it possible for such a workplace to be used variably for screen-based work and work that does not require a screen or only requires a small screen.

It is known to meet this need through the use of flexible or pliable displays which can be stowed in a space-saving manner. Display apparatuses with variable-size, flexible screens for motor vehicles or other means of transport are known from each of DE 10 2014 006 338 A1, DE 101 15 050 A1 and DE 10 2015 011614 A1. Each of the screens are mounted so as to be displaceable out of a housing into a passenger interior space and can be moved along curved movement paths, wherein they have to be supported in a large-area manner on the rear side for stabilization purposes during the movement owing to their flexibility or lack of inherent rigidity. In this way, the described display apparatuses are of mechanically complex design overall and require a relatively large amount of installation space.

### SUMMARY

An aspect of the invention includes a size-adjustable display which can be operated with little wear, takes up little installation space and still has a stability that allows it to withstand a force acting on the display, as can for example occur in the course of a touch operation (contact operation).

A display system includes a display apparatus and a housing. The display apparatus can be at least partially stowed in the housing or can be alternately retracted and extended. To this end, a drive device is provided which is configured to move or displace the display apparatus back and forth, in particular in a continuously variable manner, in dependence on a control signal, through a housing opening in the housing between a first use position, in which at least a first carrier portion of a screen carrier is arranged or stowed in a housing interior space of the housing, and at least one further use position, in which the first carrier portion also at least partially projects from the housing interior space. The drive device may also retain the display apparatus in the respective use position.

The screen carrier of the display apparatus has, at least in the first carrier portion, a first inherent rigidity, as a result of which said first carrier portion is bendable and/or foldable, in particular without being damaged in the process, when the bending radius is in a range greater than a predetermined minimum radius. A minimum radius, for example, is in a range of 3 centimeters to 15 centimeters. The first inherent rigidity may be determined or provided materially and/or structurally. For instance, the screen carrier within the first carrier portion may be formed from a material which has the desired inherent rigidity. As such material, use may be made of a rubber or another flexible or elastic material. Suitable materials are fundamentally all, in particular elastic, plastics, for example polyamides (PA). The first inherent rigidity allows the screen carrier to be moved along a curved movement path.

A flexible screen film is fastened to the screen carrier, wherein the fastening may be designed to be permanent or to not be non-destructively releasable, for example as an adhesive connection. The fastening may also be designed to be reversible or non-destructively releasable, for example through utilization of adhesion effects between the screen carrier and the screen film. The screen film may be designed as a flexible OLED display or “electronic paper” (OLED—organic light-emitting diode). Due to the flexibility or elasticity of the screen film, the outlined pliability and/or foldability of the screen carrier in the first carrier portion is firstly not restricted. Secondly, the flexible and/or elastic screen film can participate in or follow the bending and/or folding of the screen carrier, without tearing or breaking.

In an aspect of the invention, parallel guide rails which are arranged fixedly with respect to the housing and which are of curved shape in the housing interior space are provided and define a movement path which runs in curved fashion in the housing interior space and which leads through the housing opening out of the housing interior space and into the housing interior space. As counterparts to the guide rails, guide elements which are mounted so as to be movable along a respective one of the guide rails are arranged on a rear side of the first carrier portion, said rear side facing away from the screen film. The respective guide element thus retains the carrier portion on a respective guide rail.

To this end, a respective guide element is in form-fitting engagement with its respective guide rail in relation to some or all transverse directions transverse to the movement path, such that, during a movement of the display apparatus along the movement path, the display apparatus, at least in the region of the first carrier portion along the guide rails, is retained in relation to said transverse directions on the guide rail. In an aspect of the invention, a movement with only one degree of freedom (DOF), namely along the movement path or guide rail, is produced.

In other words, the guide elements engage into the respective guide rail and/or engage around them and force the screen carrier in terms of its movement onto a defined movement path. As a result, bulging of the flexible screen carrier during the moving is advantageously prevented, in particular when a shear force is applied, wherein a large-area rear reinforcement of the screen carrier can be omitted. In addition, the engagement according to an aspect of the invention and/or the encircling engagement of the guide elements with the guide rails ensures a stability of the flexible screen even in relation to a force which is exerted on a screen surface for example during a touch operation (contact operation). At the same time, the engagement according to an aspect of the invention and/or the encircling engagement of the guide elements with the guide rails prevents the screen carrier from being pulled off or pulled away from the guide rails.

One example of the invention provides for a first portion of the respective guide rail to be arranged within the housing interior space and a second portion of the respective guide rail to be arranged outside the housing interior space and to extend away from the housing opening, and for the portion projecting from the housing interior space to be of rectilinear shape. In other words, the portion projecting from the housing interior space is not curved or bent, but rather extends rectilinearly away from the housing. In other words, when being moved out of the housing, the screen carrier can thus be transferred from a curved profile of the movement path to a rectilinear profile of the movement path and vice versa. Within the housing interior space, the screen carrier is accordingly stowed in curved or bent fashion. This produces a particularly space-saving possibility for stowing the screen carrier.

In an advantageous development, the respective guide rail has a concavely curved profile, for example a circular-arc-shaped profile, along the first portion. However, other profiles of the first portion are also conceivable, which can be adapted to a respective available installation space within which the screen carrier should be placed.

In a further example of the invention, the first carrier portion at least partially has a rear honeycomb structure and/or lamellae, wherein the honeycombs and/or lamellae are of elongate shape and their longitudinal extent direction runs parallel to an axis of curvature oriented perpendicularly in relation to the movement path. In other words, the first carrier portion has structural features which at least partially determine the first inherent rigidity and have the result that the screen carrier is at least partially bendable and/or foldable. The described orientation of the lamellae and/or honeycombs in relation to the movement path assists stiffening in the transverse directions and pliability along the movement path.

In a further example of the invention, the screen carrier has a second carrier portion with a second inherent rigidity which is greater than the first inherent rigidity, wherein, in the first use position of the display apparatus, the second carrier portion at least partially extends outside the housing interior space away from the housing opening. The second inherent rigidity may be 30 to 70 percent greater than the first inherent rigidity. In an example, the first inherent rigidity is 50 percent of the second inherent rigidity. In other words, the screen carrier may be, for example, twice as inherently rigid in the region of the second carrier portion as within the first carrier portion. The differences in the inherent rigidities can be determined by different materials of the two carrier portions and/or structural features. The second carrier portion may be formed from a different material than the first carrier portion. Suitable as such a material is a metal or a metal-plastic composite material with high inherent rigidity, for example an aluminum or an aluminum-polymer composite material or a carbon composite material. This results in the advantage that the screen carrier in the region of the second carrier portion is so inherently rigid that it is stable even outside the housing. In an example, the screen carrier in the region of the second carrier portion may also be supported on the rectilinearly running second portion of a respective guide rail.

In a further example, the screen carrier has rigid stiffening elements along the rear side which also extend between the guide rails and are supported by the guide rails in the event of an operating force acting on the screen film, wherein there is a region of first inherent rigidity between in each case two stiffening elements and a dimension of the stiffening elements, measured along the movement path, is less than one third of a dimension of the region of first inherent rigidity located between said stiffening elements. In other words, the stiffening elements form stiffened regions, interrupt the regions of first inherent rigidity and are narrow in comparison with the regions of first inherent rigidity, such that a curvature of the screen carrier along the movement path is ensured in spite of the stiffening elements. At the same time, the guide elements can be arranged along the stiffening elements.

In a further example, the respective guide rail (viewed in the cross section of the guide rail) is enclosed or clamped, at least in certain regions, between a first limb and a second limb, arranged oppositely to the first limb, of the respective guide element in such a way that the first limb engages behind the respective guide rail and the second limb spaces the respective guide rail and the rear side of the first carrier portion apart from one another. In other words, the respective guide rail is clutched or at least partially enveloped by the respective guide element, such that the screen carrier is movable only along the movement path and cannot be pulled off from the guide rails. This ensures a particularly great stability of the connection between the screen carrier and the guide rails.

The respective guide element may have at least one roller element and a sliding friction element arranged oppositely to the roller element, wherein the roller element may be arranged on the first limb and the sliding friction element is arranged, for example, on the second limb. In other words, the respective guide rail is arranged between the at least one roller element and the sliding friction element. In this way, firstly low-resistance rolling along the guide rails is ensured, and secondly the sliding friction element can absorb a force acting on the screen carrier.

In a further example, the drive device has at least one pivot arm for moving the first carrier portion along the movement path and is for this purpose configured to pivot the pivot arm about an axis of rotation by a rotary motor. The pivot arm can be positioned in a foot region of the first carrier portion and can push, pull and retain the latter along a circular path. This is a mechanically particularly simple and accordingly low-wear drive mechanism which is made possible by the described arrangement of guide rails and guide elements, said arrangement making it possible, on account of the stability produced by it, to dispense with complex drive mechanisms, for example drive rolls, which would additionally support the screen carrier.

An aspect of the invention also includes a motor vehicle having a display system of the above-described type.

Aspects of the invention also include developments of the motor vehicle according to the invention which have features as have already been described in connection with the developments of the display system according to the invention. For this reason, the corresponding developments of the motor vehicle according to the invention are not described again here.

The motor vehicle according to an aspect of the invention is in the form of a motor car, in particular a passenger car or truck, or in the form of a minibus or motorcycle.

Aspects of the invention also include the combinations of the features of the described embodiments. Aspects of the invention thus also include implementations which have a respective combination of the features of several of the described embodiments, unless the embodiments have been described as being mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 shows a schematic longitudinal sectional illustration of a detail of an example of the display system according to the invention in a motor vehicle;

FIG. 2 shows an example of a schematic rear view of a detail of an example of the display system according to the invention.

### DETAILED DESCRIPTION

Reference will now be made in detail to the preferred embodiments, examples of which are illustrated in the accompanying drawings, wherein like reference numerals refer to like elements throughout.

The exemplary embodiments explained below are example embodiments of the invention. In the exemplary embodiments, the described components of the embodiments each represent individual features of the invention that should be considered independently of one another and that each also develop the invention independently of one another. The disclosure is therefore also intended to comprise combinations of the features of the embodiments other than those illustrated. Furthermore, the described embodiments are also able to be supplemented by more of the features of the invention that have already been described.

In the figures, identical reference designations each denote functionally identical elements.

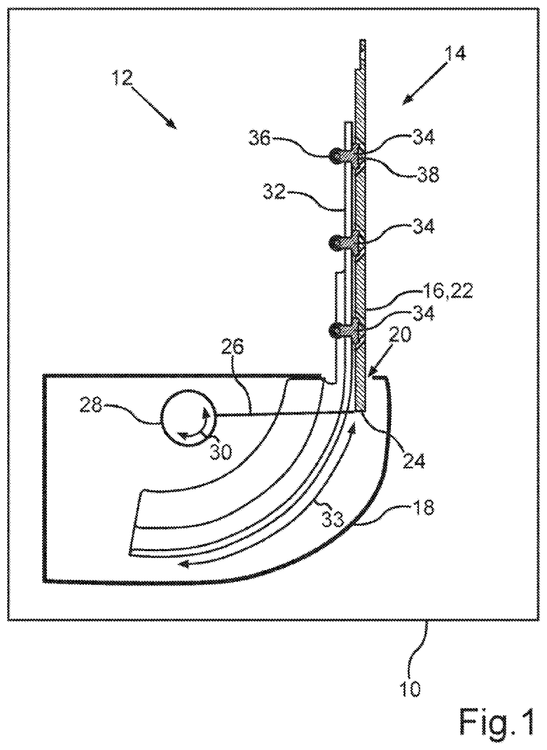

FIG. 1 shows an example of a motor vehicle 10 having a display system 12. The display system 12 comprises a display apparatus 14 with a screen carrier 16 and a housing 18. The display apparatus 14 can be pushed back and forth, in dependence on a control signal, through a housing opening 20 in the housing 18 between multiple use positions.

FIG. 1 shows a first carrier portion 22 of the screen carrier 16. The first carrier portion 22 has a first inherent rigidity, as a result of which the first carrier portion 22 is bendable and/or foldable. The first inherent rigidity can be produced by lamellae and/or honeycombs (not illustrated) along a rear side of the first carrier portion 22. FIG. 1 shows by way of example a situation in which the first carrier portion 22 is mostly outside the housing 18.

A pivot arm 26 can engage on a foot region 24 of the first carrier portion 22 and can be connected to a drive device 28, for example a rotary motor 28. By rotation about an axis of rotation in a direction of rotation 30, the pivot arm 26 can move the first carrier portion 22 in a continuously variable manner between individual use positions and retain it in a desired use position.

The display system 12 comprises parallel guide rails 32 which are arranged fixedly with respect to the housing and which are of curved shape within a housing interior space, said guide rails defining a movement path 33 which runs in bent or curved fashion at least within the housing 18. As counterparts to these guide rails 32, guide elements 34 can be arranged on a rear side of the first carrier portion 22 and can be mounted so as to be movable in relation to the guide rails 32. The guide elements 34 can each have a roller element 36 and a sliding friction element 38 arranged oppositely to the roller element 36, for example in the form of a sliding surface.

A respective guide element 34 can be in form-fitting engagement with its respective guide rail 32 in relation to some or all transverse directions transverse to the movement path 33, such that, during a movement of the display apparatus 14 along the guide rails 32, the display apparatus 14, at least in the region of the first carrier portion 22, is retained in relation to the transverse directions on the guide rails 32. The display apparatus 14 is thus forced onto the curved movement path 33 defined by the guide rails 32. For the situation shown in FIG. 1, this means that the first carrier portion 22 would be forced onto a curved movement path 33 as soon as the rotary motor 28 were to exert a clockwise rotational movement about a central axis of rotation. The rotational movement may be effected in dependence on a control signal, wherein the control signal can be generated in dependence on a respective display content to be displayed by the display apparatus 14. In other words, the control signal may be generated in dependence on a defined display size for a respective display content.

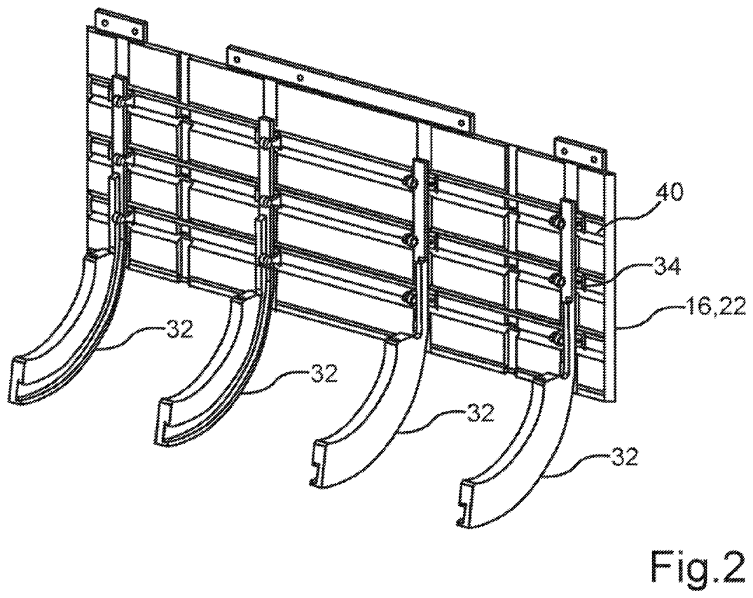

FIG. 2 shows, with reference to the elements shown and described in connection with FIG. 1, a schematic rear view of an example of a display system 12. Here, FIG. 2 shows rigid stiffening elements 40 running on the rear side along the first carrier portion 22, wherein the guide elements 34 can be arranged at uniform spacings along the stiffening elements 40.

In modern motor vehicles 10, use is almost exclusively made of one or more displays or display apparatuses 14 to present information for drivers and front passengers. Depending on the driving situation, a display size of varying magnitude is frequently necessary. This situation has already been dealt with for quite some time by retraction and extension of the display. While recently, in modern motor vehicles 10, use has been made of increasingly large displays which as a result become increasingly central elements of the cockpit configuration, the problem thus increasingly arises of concealing such large displays inside the vehicle console when not in use. Current developments in the field of flexible display panels increasingly enable the trend away from rigid, linearly moving display elements toward bendable components which can utilize the space available in the vehicle console much more flexibly and efficiently.

On account of the discussed installation space situation in the interior, solutions with increased flexibility are required. However, the pliable properties of a flexible display carrier or screen carrier 16 are in conflict with the requirements with regard to a touch operation of such displays. Here, moderate compressive rigidities and a uniform haptic operator experience are desired over the entire display surface.

In the event of bending, without further measures a bulge of the display is produced on account of the resultant stress distribution on the upper side of the flexible display carrier. This bulge is elastic and thus force-dependent.

Elasticities such as the bulging described above lead to dynamic independence in the following situations: pulling out of the display, halting of the display and manipulation or operation of a touch surface (touch-sensitive surface) of the display. When pulling out the display, the displacement travel is first converted into the deflection of the flexible display carrier. Only once a limit deflection is reached is the display pulled out. When halting the display, the effect is produced that although the drive has already been deactivated, the deflection energy stored in the flexible display carrier is dissipated in a relaxation process in the form of a display which rises slightly in time. Lastly, during the operation, it may happen that the display yields and bulges as soon as a manipulating force acts downward (z direction). There is thus no direct response behavior.

Since the flexibility of the display carrier is necessary especially in the concealed part of the display, that is to say in a region located within the housing 18, a method is presented which stiffens the visible portion of the flexible display in both directions along the display normal.

A structure is proposed in which the flexible display carrier 16, 22 is form-fittingly connected to a guide rail 32 positioned behind it by way of regularly arranged carriages or guide elements 34. The regular arrangement of the carriages 34 is effected horizontally and/or vertically (FIG. 2). In this case, a front side of the carriage 34 may have a sliding contact 38 with the rail 32, and the rear side a rolling contact implemented by way of ball bearings or roller elements 36.

All tensile forces that result in above-mentioned bulge effects of flexible display carriers are prevented by the guide rails 32 and ball bearings 36. Compressive forces acting as a result of touch operation (contact operation) are also dissipated by the carriages 34 and the guide rails 32. The elongate embodiment of the carriage contact surfaces or sliding friction elements 38 ensures that the corresponding rotational degree of freedom is trapped and thus a deflection is prevented even when force acts outside the supported points.

Overall, the examples show how a method for guiding and stabilizing pliable touch displays can be provided.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1.-10. (canceled)

11. A display system, comprising:
a display apparatus including a flexible screen film and a screen carrier to which the flexible screen film is fastened, the screen carrier including a first carrier portion, the screen carrier having a first inherent rigidity in at least the first carrier portion, and the first carrier portion being bendable and/or foldable;
a housing including a housing interior space for at least partially receiving the display apparatus and a housing opening;
a drive device configured to move the display apparatus, in response to a control signal, through the housing opening between a first use position, in which at least the first carrier portion is arranged in the housing interior space, and at least one further use position, in which the first carrier portion at least partially projects from the housing interior space;
parallel guide rails arranged fixedly with respect to the housing and being of curved shape in the housing interior space, the parallel guide rails to define a movement path which is curved in the housing interior space and which leads through the housing opening out of the housing interior space and into the housing interior space; and
guide elements mounted to be movable along a respective one of the guide rails and arranged on a rear side of the first carrier portion, said rear side facing away from the flexible screen film, wherein a respective guide element is in form-fitting engagement with its respective guide rail in relation to transverse directions transverse to the movement path, such that, during a movement of the display apparatus along the movement path, the display apparatus, at least in the region of the first carrier portion along the guide rails, is retained in relation to the transverse directions on the guide rail.

12. The display system as claimed in claim 11, wherein a first portion of the respective guide rail is within the housing interior space and a second portion of the respective guide rail is outside the housing interior space and extends away from the housing opening, and the portion projecting from the housing interior space is of rectilinear shape.

13. The display system as claimed in claim 12, wherein the respective guide rail has a concavely curved profile along the first portion.

14. The display system as claimed in claim 13, wherein the respective guide rail has a circular-arc-shaped profile along the first portion.

15. The display system as claimed in claim 11, wherein the first carrier portion at least partially has a rear honeycomb structure and/or lamellae, wherein the honeycombs and/or lamellae are of elongate shape and their longitudinal extent direction runs parallel to an axis of curvature oriented perpendicularly in relation to the movement path.

16. The display system as claimed in claim 12, wherein the first carrier portion at least partially has a rear honeycomb structure and/or lamellae, wherein the honeycombs and/or lamellae are of elongate shape and their longitudinal extent direction runs parallel to an axis of curvature oriented perpendicularly in relation to the movement path.

17. The display system as claimed in claim 13, wherein the first carrier portion at least partially has a rear honeycomb structure and/or lamellae, wherein the honeycombs and/or lamellae are of elongate shape and their longitudinal extent direction runs parallel to an axis of curvature oriented perpendicularly in relation to the movement path.

18. The display system as claimed in claim 11, wherein the screen carrier has a second carrier portion with a second inherent rigidity which is greater than the first inherent rigidity, wherein, in the first use position of the display apparatus, the second carrier portion at least partially extends outside the housing interior space away from the housing opening.

19. The display system as claimed in claim 12, wherein the screen carrier has a second carrier portion with a second inherent rigidity which is greater than the first inherent rigidity, wherein, in the first use position of the display apparatus, the second carrier portion at least partially extends outside the housing interior space away from the housing opening.

20. The display system as claimed in claim 13, wherein the screen carrier has a second carrier portion with a second inherent rigidity which is greater than the first inherent rigidity, wherein, in the first use position of the display apparatus, the second carrier portion at least partially extends outside the housing interior space away from the housing opening.

21. The display system as claimed in claim 15, wherein the screen carrier has a second carrier portion with a second inherent rigidity which is greater than the first inherent rigidity, wherein, in the first use position of the display apparatus, the second carrier portion at least partially extends outside the housing interior space away from the housing opening.

22. The display system as claimed in claim 11, wherein the screen carrier has stiffening elements along the rear side which also extend between the guide rails and are supported by the guide rails in the event of an operating force acting on the screen film, wherein there is a region of first inherent rigidity between in each case two stiffening elements and a dimension of the stiffening elements, measured along the movement path, is less than one third of a dimension of the region of first inherent rigidity located between said stiffening elements.

23. The display system as claimed in claim 12, wherein the screen carrier has stiffening elements along the rear side which also extend between the guide rails and are supported by the guide rails in the event of an operating force acting on the screen film, wherein there is a region of first inherent rigidity between in each case two stiffening elements and a dimension of the stiffening elements, measured along the movement path, is less than one third of a dimension of the region of first inherent rigidity located between said stiffening elements.

24. The display system as claimed in claim 13, wherein the screen carrier has stiffening elements along the rear side which also extend between the guide rails and are supported by the guide rails in the event of an operating force acting on the screen film, wherein there is a region of first inherent rigidity between in each case two stiffening elements and a dimension of the stiffening elements, measured along the movement path, is less than one third of a dimension of the region of first inherent rigidity located between said stiffening elements.

25. The display system as claimed in claim 11, wherein the respective guide rail is enclosed, at least in certain regions, between a first limb and a second limb, arranged oppositely to the first limb, of the respective guide element in such a way that the first limb engages behind the respective guide rail and the second limb spaces the respective guide rail and the rear side of the first carrier portion apart from one another.

26. The display system as claimed in claim 12, wherein the respective guide rail is enclosed, at least in certain regions, between a first limb and a second limb, arranged oppositely to the first limb, of the respective guide element in such a way that the first limb engages behind the respective guide rail and the second limb spaces the respective guide rail and the rear side of the first carrier portion apart from one another.

27. The display system as claimed in claim 13, wherein the respective guide rail is enclosed, at least in certain regions, between a first limb and a second limb, arranged oppositely to the first limb, of the respective guide element in such a way that the first limb engages behind the respective guide rail and the second limb spaces the respective guide rail and the rear side of the first carrier portion apart from one another.

28. The display system as claimed in claim 25, wherein the respective guide element has at least one roller element on its first limb and a sliding friction element, arranged oppositely to the roller element, on its second limb, wherein the respective guide rail is arranged between the at least one roller element and the sliding friction element.

29. The display system as claimed in claim 11, wherein the drive device has at least one pivot arm to move the first carrier portion along the movement path and is configured to pivot the pivot arm about an axis of rotation by a rotary motor.

30. A motor vehicle having a display system as claimed in claim 11.
